(19) United States
(12) Patent Application Publication
(10) Pub. No.: US 2017/0102283 A1
(43) Pub. Date: Apr. 13, 2017

(54) CALIBRATING A COLD PLANER CONVEYOR SCALE SYSTEM

(71) Applicant: Caterpillar Paving Products Inc., Brooklyn Park, MN (US)

(72) Inventor: John L. Marsolek, Watertown, MN (US)

(73) Assignee: Caterpillar Paving Products Inc., Brooklyn Park, MN (US)

(21) Appl. No.: 14/876,885

(22) Filed: Oct. 7, 2015

(51) Int. Cl. G01L 25/00; B65G 43/00; E01C 23/088; E01C 23/12; G01G 23/01; G01G 11/00

(52) U.S. Cl. CPC G01L 25/00; G01G 23/01; G01G 11/006; E01C 23/088; E01C 23/127; B65G 43/00

(57) ABSTRACT

A system for calibrating a force transducer that measures a magnitude of a force acting on a conveyor of a cold planer is disclosed. The system may receive, from the force transducer, a first signal indicative of the magnitude of the force acting on the conveyor of the cold planer. The system may compare the first signal and a second signal associated with calibrating the force transducer. The system may output a third signal, indicative of a relationship between the first signal and the second signal, based on comparing the first signal and the second signal.

### TECHNICAL FIELD

The present disclosure relates generally to calibrating a conveyor scale system and, more particularly, to calibrating a conveyor scale system of a cold planer.

### BACKGROUND

Asphalt-surfaced roadways are built to facilitate vehicular travel. Depending upon usage density, base conditions, temperature variation, moisture levels, and/or physical age, the surfaces of the roadways eventually become misshapen and unable to support wheel loads. In order to rehabilitate the roadways for continued vehicular use, spent asphalt is removed in preparation for resurfacing.

Cold planers, sometimes also called road mills or scarifiers, are used to break up and remove layers of an asphalt roadway. A cold planer typically includes a frame propelled by tracked or wheeled drive units. The frame supports an engine, an operator station, a milling drum, and conveyors. The milling drum, fitted with cutting tools, is rotated through a suitable interface with the engine to break up the surface of the roadway. The broken up roadway material is deposited by the milling drum onto the conveyors, which transfer the broken up material into haul vehicles for removal from the worksite. When a haul vehicle is filled, the filled haul vehicle is replaced with an empty haul vehicle. The filled haul vehicle transports the broken up material to a different location to be reused as aggregate in new asphalt or otherwise recycled. This transport process repeats until the milling process is finished.

Operators may wish to fill each haul vehicle to a maximum legal or desired capacity before replacing a filled haul vehicle with an empty haul vehicle in order to reduce waste, improve efficiency, and comply with applicable laws. To help calculate how much material has been milled and loaded into a haul vehicle, a manufacturer may equip the haul vehicle with a scale system. However, it may be costly to equip every haul vehicle with a scale system, rather than equipping a cold planer with a scale system that can be used to weigh milled material for every haul vehicle. Therefore, a manufacturer may equip a conveyor of a cold planer with a scale system to measure the weight of the milled material. The scale system may sense a parameter indicative of the force required to support material on the conveyer. During operation, however, a belt of the conveyor may loosen, which may reduce the accuracy of the scale system over time. An operator may calibrate the scale system using trial and error, which may be costly and time consuming

One attempt to control the tension of a conveyor belt for a road milling machine is disclosed in U.S. Pat. No. 5,389,045 that issued to Lyons on Feb. 14, 1995 (“the '045 patent”). In particular, the '045 patent discloses a conveyor belt tensioning mechanism for controlling the tension of a conveyor belt for a road milling machine. The conveyor belt tensioning mechanism includes a pulley at either end of the conveyor belt, and means for moving a pulley to apply tension force to the conveyor belt and to tighten the conveyor belt. The conveyor belt tensioning mechanism also includes means for indicating when the tension force is within a preselected tension force range.

While the mechanism of the '045 patent may be used to calibrate a conveyor scale system in some cases, this mechanism may introduce problems. For example, the mechanism of the '045 patent introduces moving parts to the conveyor, such as parts to move the pulley to apply tension force to the conveyor. Such moving parts may be subject to mechanical failure, particularly during operation of the milling machine, when debris may accumulate on or around these moving parts.

The conveyor scale system of the present disclosure solves one or more of the problems set forth above and/or other problems in the art.

### SUMMARY

In one aspect, the present disclosure is related to a cold planer. The cold planer may include a frame, at least one traction device configured to support the frame, an engine supported by the frame and configured to drive the at least one traction device to propel the cold planer, and a milling drum. The cold planer may include a first conveyor with a first charge end, configured to receive material removed by the milling drum, and a first discharge end. The cold planer may include a second conveyor with a second charge end, configured to receive material from the first discharge end of the first conveyor, and a second discharge end. The cold planer may include a force transducer configured to generate a force signal indicative of a magnitude of a force acting on at least a portion of the second conveyor. The cold planer may include a controller, in communication with the force transducer, configured to compare the force signal and a set point signal indicative of a set point associated with calibrating the force transducer, and to output a calibration signal based on comparing the force signal and the set point signal.

In another aspect, the present disclosure is related to a cold planer including a frame, at least one traction device configured to support the frame, and an engine supported by the frame and configured to drive the at least one traction device to propel the cold planer. The cold planer may include a milling drum, one or more conveyors configured to convey material removed by the milling drum, and a force transducer configured to generate a first signal indicative of a magnitude of a force acting on at least a portion of a conveyor of the one or more conveyors. The cold planer may include a controller, in communication with the force transducer, configured to compare the first signal and a second signal associated with calibrating the force transducer, and to output a third signal based on comparing the first signal and the second signal. The cold planer may include an actuator configured to adjust the force transducer based on the third signal.

In yet another aspect, the present disclosure is related to a method associated with calibrating a force transducer that measures a magnitude of a force acting on a conveyor of a cold planer. The method may include receiving, by a controller and from the force transducer, a first signal indicative of the magnitude of the force acting on the conveyor of the cold planer. The method may include comparing, by the controller, the first signal and a second signal associated with calibrating the force transducer. The method may include outputting, by the controller, a third signal, indicative of a relationship between the first signal and the second signal, based on comparing the first signal and the second signal.

### BRIEF DESCRIPTION OF THE DRAWINGS

FIG. 1 is a diagram of an example cold planer;

FIG. 2 is a diagram of an example conveyor that may be used with the cold planer of FIG. 1;

FIG. 3 is a diagram of an example roller assembly that may be used with the conveyor of FIG. 2; and

FIG. 4 is a diagram of an example conveyor scale system that may be used with the cold planer of FIG. 1, and that may be calibrated as described herein.

### DETAILED DESCRIPTION

A cold planer may refer to a machine used to remove material, such as hardened asphalt, from a ground surface, such as a roadway. A conveyor scale system may determine weight measurements for material carried by a conveyor of the cold planer. During operation of the cold planer, the conveyor may undergo temperature changes or may encounter other factors that reduce the accuracy of the weight measurements determined by the conveyor scale system. Implementations described herein assist with calibrating a conveyor scale system of a cold planer that removes material, such as asphalt, from a ground surface.

For the purpose of this disclosure, asphalt may refer to a mixture of aggregate and asphalt cement. Asphalt cement is a brownish-black solid or semi-solid mixture of bitumens obtained as a byproduct of petroleum distillation. The asphalt cement can be heated and mixed with the aggregate for use in paving roadway surfaces, where the mixture hardens upon cooling. A cold planer may be used to remove layers of hardened asphalt from an existing roadway. Additionally, or alternatively, the cold planer may be used to remove cement or other roadway surfaces, or to remove non-roadway surface material, such as in a mining operation.

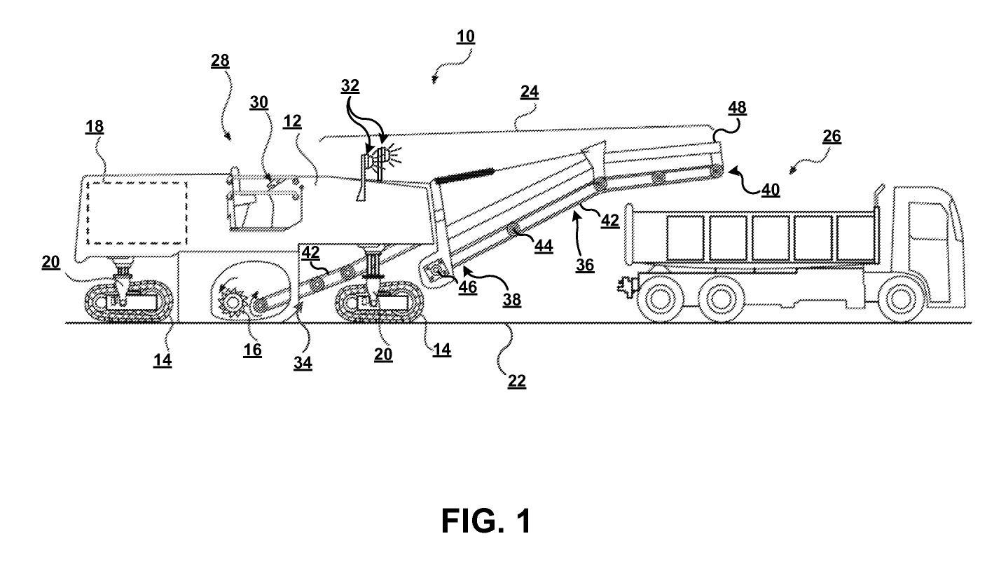

FIG. 1 is a diagram of an example cold planer 10 having a frame 12 supported by one or more traction devices 14, a milling drum 16 rotationally supported under a belly of frame 12, and an engine 18 mounted to frame 12 and configured to drive traction devices 14 and milling drum 16. Traction devices 14 may include either wheels or tracks connected to actuators 20 that are adapted to controllably raise and lower frame 12 relative to a ground surface. Raising and lowering of frame 12 may function to vary a milling depth of milling drum 16 into a work surface 22. In some implementations, the same or different actuators 20 may be used to steer cold planer 10 and/or to adjust a travel speed of traction devices 14 (e.g., to speed up or brake traction devices 14). A conveyor system 24 may be connected at a leading end to frame 12 and configured to transport material away from milling drum 16 and into a receptacle, such as a waiting haul vehicle 26.

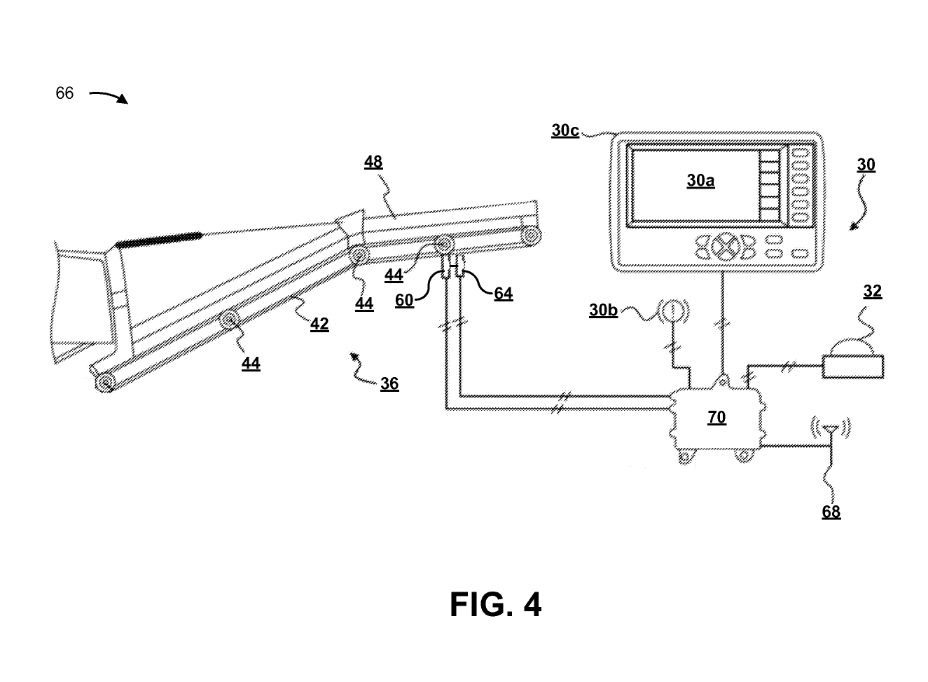

Frame 12 may support an operator station 28. In some implementations, operator station 28 may be located at a side of cold planar 10 opposite milling drum 16. In some implementations, operator station 28 may be located offboard cold planer 10. For example, operator station 28 may include a remote control, such as a handheld controller, that an operator may use to control cold planer 10 from anywhere on a worksite. Additionally, or alternatively, operator station 28 may include a combination of hardware and software, such as a software program executing on a computer or a processor. In some implementations, cold planer 10 may be autonomous and may not include operator station 28. Operator station 28 may house any number of interface devices 30 used to control cold planer 10. Interface devices 30 are described in more detail in connection with FIG. 4, below.

Cold planer 10 may include one or more signaling devices 32 attached to frame 12. Signaling device 32 may output a visible signal and/or an audible signal associated with operating and/or calibrating cold planer 10. For example, signaling device 32 may include one or more signaling lights, which may be used by an operator of cold planer 10 to communicate information to an operator of haul vehicle 26. Additionally, or alternatively, the one or more signaling lights may be used to communicate information to an operator of cold planer 10 regarding calibration of cold planer 10.

Conveyor system 24 may include a first conveyor 34 adjacent milling drum 16. First conveyor 34 is configured to receive milled material from milling drum 16 at a charge end of first conveyor 34, and to provide, at a discharge end of first conveyor 34, the milled material to a second conveyor 36. Second conveyor 36 may receive the milled material at a charge end 38 of second conveyor 36, positioned below first conveyor 34, and may dispense the milled material into haul vehicle 26 at an elevated discharge end 40 of second conveyor 36. Second conveyor 36 may be rotatably attached to frame 12 at charge end 38 so that a height at which milled material leaves second conveyor 36 at discharge end 40 may be adjusted.

Conveyors 34 and 36 may each include a belt 42 that is supported by one or more roller assemblies 44 and driven by a motor 46 (only one motor 46 is shown in FIG. 1). Motor 46 may include, for example, a hydraulic motor, an electric motor, or the like. Second conveyor 36 may include a cover 48 to prevent debris from falling and/or accumulating on belt 42 or other components of second conveyor 36.

As indicated above, FIG. 1 is provided as an example. Other examples are possible and may differ from what was described with regard to FIG. 1.

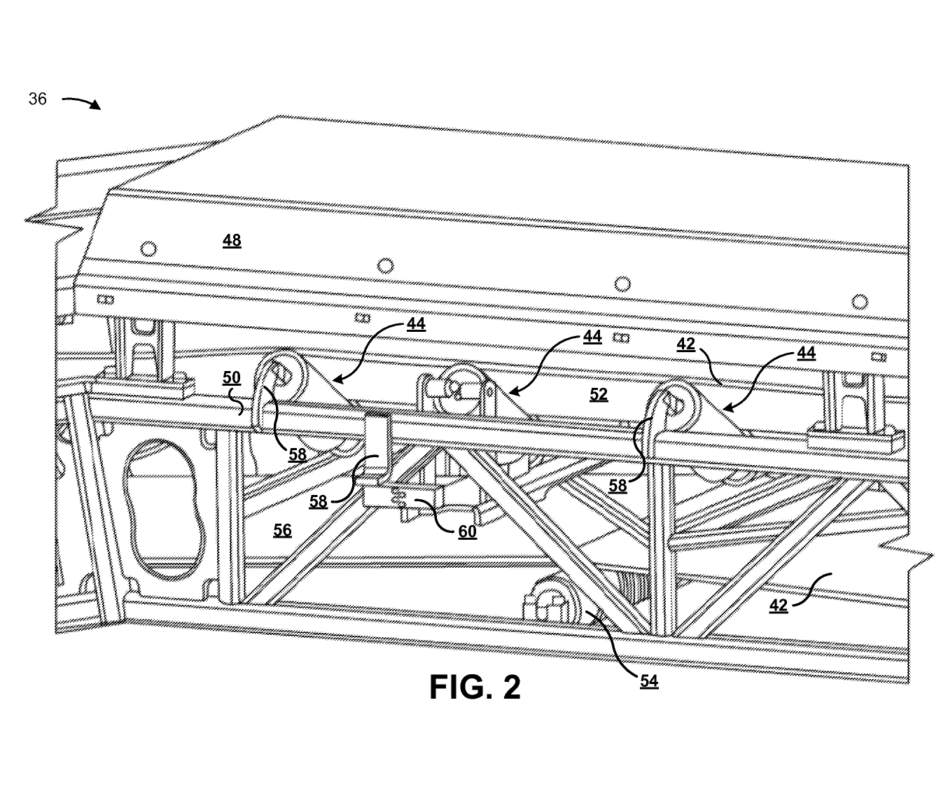

FIG. 2 is a diagram of an example second conveyor 36 that may be used with cold planer 10. As shown in FIG. 2, second conveyor 36 may include a frame 50 that is configured to support roller assemblies 44 and cover 48. Roller assemblies 44 may be attached to frame 50 and configured to support an upper portion 52 of belt 42. Upper portion 52 of belt 42 may carry milled material from charge end 38 (referring to FIG. 1) to discharge end 40 of second conveyor 36, as belt 42 is driven by motor 46. Return idlers 54 (only one shown in FIG. 2) may be attached to frame 50 and configured to support a lower portion 56 of belt 42 as belt 42 returns to charge end 38 to receive more material.

Under the weight of milled material, belt 42 may apply a downward force on roller assemblies 44 during travel of belt 42 from charge end 38 to discharge end 40 of second conveyor 36. Roller assemblies 44 may be attached to frame 50 via anchors 58 and configured to support this downward force. To help determine the magnitude of the downward force, at least one roller assembly 44 may include a force transducer 60. For example, force transducer 60 may be attached between roller assembly 44 and anchor 58, so that the downward force (e.g., a gravitational force normal to belt 42) caused by the weight of milled material acts on force transducer 60. Force transducer 60 may be configured to generate an electrical signal (e.g., a force signal) based on an applied force, and the electrical signal may be indicative of the magnitude of the force acting on second conveyor 36 by the weight of the milled material. In some implementations, force transducer 60 may include a load cell that includes a strain gauge (e.g., a wire, a thin film, an elastic element, an electrical resistance, a foil, etc.). In some implementations, force transducer 60 may include another type of force transducer, such as a piezoelectric crystal device, a magneto-elastic device, a vibrating element, or the like.

In some implementations, frame 50 may support multiple roller assemblies 44 along a width of belt 42 (e.g., a width that is perpendicular to a direction of movement of belt 42). For example, frame 50 may support a first roller assembly 44 on a first side of belt 42, and a second roller assembly 44 on a second side of belt 42. Each of these roller assemblies 44 may be configured to support at least a portion of the downward force applied to belt 42 by the milled material, and each roller assembly 44 may include a force transducer 60 configured to generate an electrical signal (e.g., a force signal) indicative of a magnitude of the force acting on a portion of belt 42 supported by a corresponding roller assembly 44.

Thus, a first force transducer 60 may be located proximate to a first side of belt 42 of second conveyor 36 (e.g., on one end along a width of belt 42), and a second force transducer 60 may be located proximate to a second side of belt 42 of second conveyor 36 (e.g., on the other end along the width of belt 42). Based on this configuration, first force transducer 60 may generate a first force signal indicative of a magnitude of a first force acting on a first portion of belt 42, and second force transducer 60 may generate a second force signal indicative of a magnitude of a second force acting on a second portion of belt 42. Two force transducers 60 are described as being located along a width of second conveyor 36 as an example. In practice, a greater or lesser number of force transducers 60 may be located along a width of second conveyor 36 to measure the weight of milled material carried by belt 42.

As indicated above, FIG. 2 is provided as an example. Other examples are possible and may differ from what was described with regard to FIG. 2.

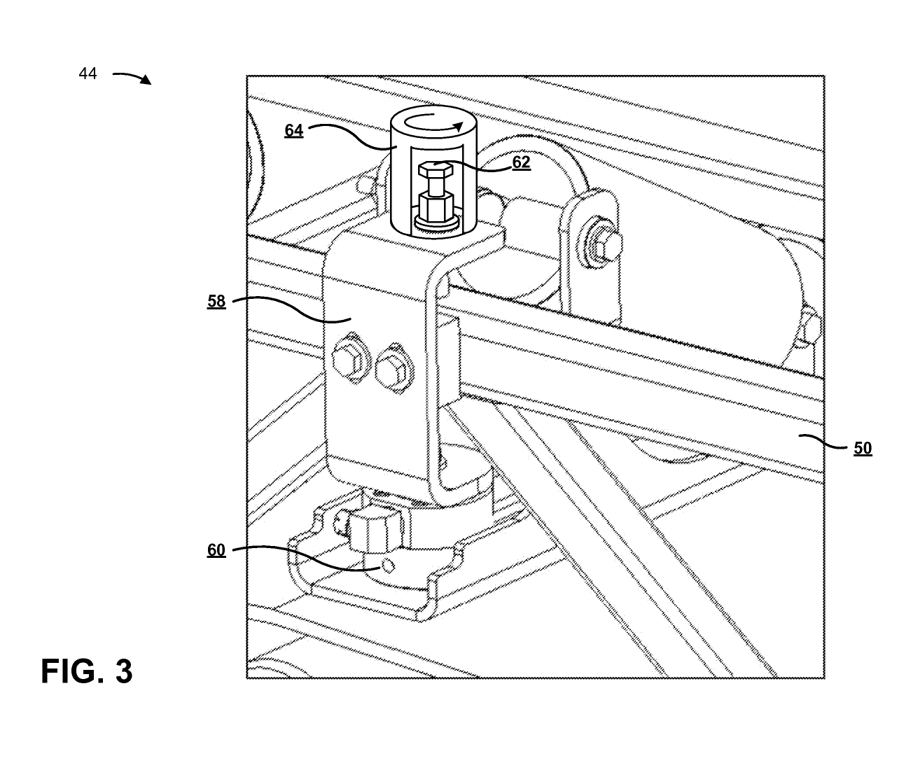

FIG. 3 is a diagram of an example roller assembly 44 that may be used with second conveyor 36. As shown in FIG. 3, roller assembly 44 may be anchored to frame 50 via an anchor 58. In some implementations, roller assembly 44 may include force transducer 60 and adjuster 62. In some implementations, roller assembly 44 may include force transducer 60, adjuster 62, and actuator 64.

Adjuster 62 may be used to adjust force transducer 60 to modify a measurement of force transducer 60 and a corresponding force signal output by force transducer 60. For example, adjuster 62 may be used to adjust a position of force transducer 60 relative to upper portion 52 of belt 42. When force transducer 60 is moved closer to upper portion 52 of belt 42, force transducer 60 may measure a larger magnitude for the force acting on belt 42. Likewise, when force transducer 60 is moved farther from upper portion 52 of belt 42, force transducer 60 may measure a smaller magnitude for the force acting on belt 42. Adjuster 62 may include a bolt, a screw, a clamp, or other suitable devices for adjusting a position of force transducer 60. Additionally, or alternatively, adjuster 62 may be used to attach anchor 58 to frame 50.

In some implementations, an operator may manually adjust adjuster 62 (e.g., by tightening or loosening a bolt, screw, clamp, etc.) to adjust a position of force transducer 60 relative to upper portion 52 of belt 42. Additionally, or alternatively, actuator 64 may be used to adjust a position of force transducer 60 relative to upper portion 52 of belt 42. In some implementations, actuator 64 may receive an electrical signal, and may adjust a position of force transducer 60 based on the electrical signal. For example, actuator 64 may include a rotary actuator configured to adjust adjuster 62, such as by loosening or tightening adjuster 62. As another example, actuator 64 may include a linear actuator configured to adjust a position of force transducer 60, such as by adjusting a position of anchor 58 attached to force transducer 60.

As indicated above, FIG. 3 is provided as an example. Other examples are possible and may differ from what was described with regard to FIG. 3.

FIG. 4 is a diagram of an example conveyor scale system 66 that may be used with cold planer 10, and that may be calibrated as described herein. As shown in FIG. 4, conveyor scale system 66 may be associated with cold planer 10, and may include components that cooperate to automatically calibrate force transducer 60 and/or to provide an indication of a manner in which force transducer 60 is to be manually calibrated. These components may include one or more interface devices 30 (e.g., a display device 30a, a warning device 30b, and an input device 30c), signaling device 32, force transducer 60, actuator 64, a communication device 68, and a controller 70 connected with the other components.

Display device 30a may be configured to display information associated with the operation and/or calibration of cold planer 10. Warning device 30b may be configured to audibly and/or visually alert the operator of cold planer 10 regarding the operation and/or calibration of cold planer 10. Input device 30c may be configured to receive input from the operator of cold planer 10 to control the operation and/or calibration of cold planer 10.

Input device 30c may include, for example, an analog input device that receives control instructions via one or more buttons, switches, dials, levers, or the like. Additionally, or alternatively, input device 30c may include a digital component, such as one or more soft keys, touch screens, and/or visual displays. Input device 30c may be configured to generate one or more signals indicative of various parameters associated with cold planer 10 and/or a surrounding environment of cold planer 10 based on input received from the operator. Cold planer 10 may include other interface devices 30 (e.g., control devices) in some implementations, and one or more of the interface devices 30 described above may be combined into a single interface device 30, if desired.

In some implementations, an operator of cold planer 10 may interact with interface device 30 to initiate calibration of force transducer 60. For example, the operator may interact with an input mechanism (e.g., a button, a knob, etc.) of input device 30c to start a calibration mode for conveyor scale system 66 of cold planer 10. Additionally, or alternatively, the operator may interact with input device 30c to indicate whether controller 70 is to calibrate conveyor scale system 66 using a manual calibration mode or an automatic calibration mode, as described in more detail below. Based on the input, input device 30c may provide a signal to controller 70 to initiate calibration of one or more force transducers 60.

Controller 70 may calibrate force transducer 60 by comparing a force signal, received from force transducer 60, and a set point signal indicative of a set point associated with calibrating force transducer 60. For example, controller 70 may use a set point value stored in memory to generate the set point signal (e.g., based on a factory setting associated with cold planer 10 and/or second conveyor 36). Additionally, or alternatively, controller 70 may receive the set point signal from input device 30c and/or communication device 68 based on input provided by an operator of cold planer 10. Communication device 68 may include a device that enables sending and receiving of information between controller 70 and an offboard device (e.g., a remote operator station 28, a handheld device, etc.). The information may be sent and received via a wired link and/or a wireless link.

Controller 70 may compare the force signal and the set point signal, and may generate a calibration signal based on the comparison. As described herein, comparing the force signal and the set point signal may refer to comparing the actual signals or values represented by the signals (e.g., the magnitude of the force measured by force transducer 60, and the set point). In some implementations, the calibration signal may indicate a relationship between the force signal and the set point signal. In some implementations, controller 70 may generate the calibration signal based on an amount by which the force signal and the set point signal differ from one another.

As an example, controller 70 may generate a first calibration signal when the force signal exceeds the set point signal and/or when the force signal exceeds the set point signal by a threshold amount. Additionally, or alternatively, the first calibration signal may indicate an amount by which the force signal exceeds the set point signal. Likewise, controller 70 may generate a second calibration signal when the set point signal exceeds the force signal and/or when the set point signal exceeds the force signal by a threshold amount. Additionally, or alternatively, the second calibration signal may indicate an amount by which the set point signal exceeds the force signal. In some implementations, controller 70 may generate a third calibration signal when the force signal and the set point signal are within a threshold tolerance of one another.

The calibration signal may indicate a manner in which force transducer 60 and/or adjuster 62 is to be adjusted to calibrate force transducer 60. For example, when the force signal exceeds the set point signal, this may indicate that the magnitude of the force measured by force transducer 60 is too high (e.g., greater than an accurate calibration point). Thus, the calibration signal may indicate that force transducer 60 is to be adjusted to decrease the measured magnitude. Likewise, when the set point signal exceeds the force signal, this may indicate that the magnitude of the force measured by force transducer 60 is too low (e.g., less than an accurate calibration point). Thus, the calibration signal may indicate that force transducer 60 is to be adjusted to increase the measured magnitude. When the force signal and the set point signal are within a threshold tolerance, the calibration signal may indicate that force transducer 60 is accurately calibrated.

In some implementations, controller 70 may receive an indication that conveyor scale system 66 is to be calibrated using manual calibration (e.g., a manual calibration mode). In this case, controller 70 may provide the calibration signal to indicate a manner in which an operator of cold planer 10 is to adjust force transducer 60 and/or adjuster 62. For example, controller 70 may provide the calibration signal to interface device 30, which may provide, via display device 30a, information that indicates a manner in which force transducer 60 and/or adjuster 62 is to be adjusted to accurately calibrate force transducer 60. For example, the displayed information may indicate, based on the calibration signal, that the operator is to loosen or tighten adjuster 62. Additionally, or alternatively, controller 70 may provide the calibration signal to warning device 30b, which may output a visible or audible signal for an operator to assist the operator in calibrating force transducer 60 via adjuster 62. Additionally, or alternatively, controller 70 may provide the calibration signal to communication device 68, which may provide information to another device, such as a portable device used by the operator of cold planer 10.

In some implementations, controller 70 may provide the calibration signal to signaling device 32, and signaling device 32 may output a visible signal and/or an audible signal based on the calibration signal. Signaling device 32 may include one or more signal lights of cold planer 10. When cold planer 10 is not in a calibration mode (e.g., when cold planer 10 is in an operating mode), a signal light may communicate information associated with performing a milling operation, such as by notifying an operator of haul vehicle 26 regarding operation of haul vehicle 26 (e.g., a distance between haul vehicle 26 and cold planer 10, an indication of whether haul vehicle 26 has been filled to a desired weight, etc.), by notifying an operator of cold planer 10 regarding operation of cold planer 10 (e.g., a distance between milling drum 16 and work surface 22, etc.), or the like.

When cold planer 10 is in a calibration mode, the signal light may communicate information associated with calibrating conveyor scale system 66 (e.g., force transducer 60 and/or adjuster 62). For example, signaling device 32 may power different colored lights based on a calibration signal that indicates a manner in which conveyor scale system 66 is to be adjusted (e.g., whether to increase or decrease a magnitude of a force measured by force transducer 60, whether to move force transducer 60 toward or away from upper portion 52 of belt 42, etc.). For example, a first colored light may indicate that the force signal exceeds the set point signal, a second colored light may indicate that the set point signal exceeds the force signal, and a third colored light may indicate that the force signal and the set point signal are within a threshold tolerance of one another. An operator of cold planer 10 may manually adjust conveyor scale system 66, such as by adjusting force transducer 60 and/or adjuster 62, by observing the color of the signal light.

As another example, signaling device 32 may control a rate at which a signal light flashes (e.g., an interval between flashes) based on the calibration signal. For example, a longer interval between flashes may indicate that the force signal and the set point signal differ by a larger amount, while a shorter interval between flashes may indicate that the force signal and the set point signal differ by a smaller amount. As another example, a longer interval between flashes may indicate that the force signal exceeds the set point signal, while a shorter interval between flashes may indicate that the set point signal exceeds the force signal. A solid light may indicate that the force signal and the set point signal are within a threshold tolerance of one another. An operator of cold planer 10 may manually adjust conveyor scale system 66 by observing the interval between flashes of the signal light, and by adjusting conveyor scale system 66 until the signal light turns solid.

As another example, signaling device 32 may power different signal lights of signaling device 32 based on the calibration signal. For example, signaling device 32 may include two signal lights. In this case, signaling device 32 may power a first signal light when the force signal exceeds the set point signal, and may power a second signal light when the set point signal exceeds the force signal. In some implementations, signaling device 32 may power both signal lights when the force signal and the set point signal are within a threshold tolerance of one another. An operator of cold planer 10 may manually adjust conveyor scale system 66 by observing which signal light is powered, and by adjusting conveyor scale system 66 until both signal lights are powered.

Controller 70 and signaling device 32 may cooperate to indicate a manner in which conveyor scale system 66 is to be adjusted using one or more of the techniques described above regarding controlling signal lights of signaling device 32. By controlling the signal lights based on the calibration signal as described above, controller 70 and signaling device 32 may instruct an operator as to a manner in which conveyor scale system 66 is to be properly calibrated.

In some implementations, cold planer 10 may include multiple signaling devices 32, which may correspond to multiple force transducers 60. For example, a first signaling device 32 may be attached to a first side of cold planer 10, and a second signaling device 32 may be attached to a second side of cold planer 10 (as shown in FIG. 1). In this case, first signaling device 32 may provide information regarding calibrating a first force transducer 60 located proximate to the first side of cold planer 10 (e.g., a first side of second conveyor 36). Similarly, second signaling device 32 may provide information regarding calibrating a second force transducer 60 located proximate to the second side of cold planer 10 (e.g., a second side of second conveyor 36).

In some implementations, when conveyor scale system 66 includes multiple force transducers 60 (e.g., along a width of belt 42 and/or roller assembly 44), controller 70 may compare force signals from the multiple force transducers 60 to the same set point signal. In some implementations, when conveyor scale system 66 includes multiple force transducers 60, controller 70 may compare force signals from the multiple force transducers 60 to different set point signals corresponding to the multiple force transducers 60. In some implementations, controller 70 may output multiple calibration signals corresponding to the multiple force transducers 60.

In some implementations, controller 70 may receive an indication that conveyor scale system 66 is to be calibrated using automatic calibration (e.g., an automatic calibration mode). In this case, controller 70 may provide the calibration signal to actuator 64, and actuator 64 may adjust force transducer 60 and/or adjuster 62 based on the calibration signal. For example, if the calibration signal indicates that the force signal exceeds the set point signal, then actuator 64 may move force transducer 60 away from an upper portion 52 of belt 42 of second conveyor 36, thereby decreasing the measured force signal. Likewise, if the calibration signal indicates that the set point signal exceeds the force signal, then actuator 64 may move force transducer 60 toward an upper portion 52 of belt 42 of second conveyor 36, thereby increasing the measured force signal. Actuator 64 may move force transducer 60 by acting directly on force transducer 60 or by acting on adjuster 62 to adjust a position of force transducer 60.

Controller 70 may include one or more processors (e.g., one or more central processing units) capable of being programmed to perform one or more functions described herein. Controller 70 may be implemented in hardware, firmware, or a combination of hardware and software. Additionally, or alternatively, controller 70 may include a memory, a secondary storage device, an input component, an output component, a communication interface for interacting with external devices, or any other component for accomplishing tasks consistent with the present disclosure. In some implementations, controller 70 may execute one or more instructions, stored by a non-transitory computer-readable medium, to perform the functions described herein.

As indicated above, FIG. 4 is provided as an example. Other examples are possible and may differ from what was described with regard to FIG. 4.

### INDUSTRIAL APPLICABILITY

The disclosed conveyor scale system 66 may be used with any cold planer 10 where accurately determining the weight of milled material is important. The disclosed conveyor scale system 66 may provide information for accurately calibrating a force transducer 60 that measures a weight of milled material by measuring the force applied to a conveyor (e.g., second conveyor 36) of cold planer 10. A controller 70 included in conveyor scale system 66 may compare a force signal, indicative of the magnitude of the force, and a set point signal indicative of a set point associated with calibrating force transducer 60. Controller 70 may provide output to instruct an operator as to a manner in which conveyor scale system 66 is to be adjusted for accurate calibration, or may automatically adjust conveyor scale system 66 for accurate calibration. Operation of conveyor scale system 66, and calibration thereof, will now be explained.

During operation of cold planer 10, milling drum 16 may remove a portion of work surface 22 in the path of cold planer 10 as cold planer 10 traverses work surface 22. Material removed by milling drum 16 may be transferred by first conveyor 34 to second conveyor 36, and second conveyor 36 may discharge the material into haul vehicle 26. As second conveyor 36 transfers material from charge end 38 to discharge end 40, force transducer 60, attached to roller assemblies 44, may sense the weight of the material and generate a force signal indicative of a force acting on second conveyor 36. Force transducer 60 may communicate the force signal to controller 70.

Controller 70 may use the force signal to determine a weight of milled material, and may output information that identifies the weight of the milled material. An operator of cold planer 10 and/or haul vehicle 26 may use the weight to determine when a weight of milled material in haul vehicle 26 is approaching or has met a maximum legal limit or desired capacity of milled material. When the limit or capacity has been met, the filled haul vehicle 26 may be replaced with an empty haul vehicle 26 in order to reduce waste, improve efficiency, and comply with applicable laws.

However, during operation of cold planer 10, environmental factors may reduce an accuracy of the weight measured by force transducer 60. For example, belt 42 may loosen or tighten, debris may accumulate on or around second conveyor 36, etc., which may reduce the accuracy of a measurement of force transducer 60. When force transducer 60 provides inaccurate measurements, the calculated weight of milled material may be inaccurate. Inaccurate weight measurements may cause haul vehicle 26 to be overfilled, which may violate applicable laws. Alternatively, inaccurate weight measurements may cause haul vehicle 26 to be underfilled, which may reduce efficiency and increase waste. Furthermore, operators of cold planer 10 and/or haul vehicle 26 may be compensated based on a weight of milled material. In this case, inaccurate weight measurements may cause the operators to be overpaid or underpaid.

Prior to or during operation of cold planer 10, controller 70 may compare a force signal, measured by force transducer 60, to a set point signal associated with calibrating force transducer 60. Based on the comparison, controller 70 may output a calibration signal that indicates a manner in which to adjust force transducer 60 to increase an accuracy of the force signal and, therefore, a calculation of the weight of the milled material. In some cases, controller 70 may provide the calibration signal to a device that provides a visible or audible signal. The visible or audible signal may instruct an operator as to a manner in which force transducer 60 is to be adjusted to increase the accuracy of the force signal. In this way, the operator may adjust force transducer 60 to increase the accuracy of the calculated weight of the milled material, thereby increasing efficiency, reducing waste, and ensuring compliance with applicable laws.

In some cases, controller 70 may provide the calibration signal to actuator 64 to automatically calibrate force transducer 60, rather than relying on manual calibration by an operator. This may increase a speed and an accuracy of the calibration process, and may further increase efficiency, reduce waste, and ensure compliance with applicable laws.

Several advantages may be associated with the disclosed conveyor scale system 66 and calibration thereof. For example, without controlling calibration of conveyor scale system 66 as described herein, an operator of cold planer 10 may rely on trial and error to calibrate conveyor scale system 66, which may be costly, time consuming, and error prone. By calibrating conveyor scale system 66 as described herein, controller 70 may provide the operator with information that indicates a manner in which conveyor scale system 66 is to be manually calibrated, which may speed up the calibration process, reduce cost, and increase an accuracy of conveyor scale system 66. Furthermore, controller 70 may automatically calibrate conveyor scale system 66 in some implementations, which may further speed up the calibration process, reduce cost, and increase the accuracy of conveyor scale system 66. By improving the accuracy of conveyor scale system 66, controller 70 may increase efficiency, reduce waste, and ensure compliance with applicable laws relating to weighing and/or hauling milled material.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations are possible in light of the above disclosure or may be acquired from practice of the implementations. It is intended that the specification be considered as an example only, with a true scope of the disclosure being indicated by the following claims and their equivalents.

What is claimed is:

1. A cold planer, comprising:
a frame;
at least one traction device configured to support the frame;
an engine supported by the frame and configured to drive the at least one traction device to propel the cold planer;
a milling drum;
a first conveyor comprising a first charge end, configured to receive material removed by the milling drum, and a first discharge end;
a second conveyor comprising a second charge end, configured to receive material from the first discharge end of the first conveyor, and a second discharge end;
a force transducer configured to generate a force signal indicative of a magnitude of a force acting on at least a portion of the second conveyor; and
a controller, in communication with the force transducer, configured to:
compare the force signal and a set point signal indicative of a set point associated with calibrating the force transducer; and
output a calibration signal based on comparing the force signal and the set point signal.

2. The cold planer of claim 1, wherein the calibration signal controls a signaling device that outputs a visible signal or an audible signal based on the calibration signal.

3. The cold planer of claim 2, wherein the signaling device comprises a signal light of the cold planer.

4. The cold planer of claim 1, wherein the controller is configured to:
receive input associated with initiating calibration of the force transducer; and
compare the force signal and the set point signal based on receiving the input associated with initiating calibration of the force transducer.

5. The cold planer of claim 1, further comprising an interface device configured to:
receive the calibration signal; and
provide, based on the calibration signal, information that indicates a manner in which the force transducer is to be adjusted.

6. The cold planer of claim 1, wherein the force transducer is a first force transducer configured to generate a first force signal indicative of a first magnitude of a first force acting on a first portion of the second conveyor; and
wherein the cold planer further comprises:
a second force transducer configured to generate a second force signal indicative of a second magnitude of a second force acting on a second portion of the second conveyor.

7. The cold planer of claim 6, wherein the set point signal is a first set point signal; and
wherein the controller is configured to:
compare the first force signal and the first set point signal;
output a first calibration signal, associated with calibrating the first force transducer, based on comparing the first force signal and the first set point signal;
compare the second force signal and a second set point signal; and
output a second calibration signal, associated with calibrating the second force transducer, based on comparing the second force signal and the second set point signal.

8. The cold planer of claim 7, further comprising:
a first signaling device that outputs a first visible or audible signal based on the first calibration signal; and
a second signaling device that outputs a second visible or audible signal based on the second calibration signal.

9. The cold planer of claim 6, wherein the first force transducer is located proximate to a first side of the second conveyor; and
wherein the second force transducer is located proximate to a second side of the second conveyor.

10. The cold planer of claim 1, further comprising a signaling device that outputs a visible or audible signal when the force signal differs from the set point signal by a threshold amount.

11. The cold planer of claim 10, wherein the visible or audible signal is based on an amount by which the force signal differs from the set point signal.

12. The cold planer of claim 1, further comprising a signaling device that outputs a visible or audible signal when the set point signal and the force signal are within a threshold tolerance.

13. The cold planer of claim 1, further comprising a signaling device configured to:
output a first visible or audible signal when the force signal exceeds the set point signal by a first threshold amount;
output a second visible or audible signal when the set point signal exceeds the force signal by a second threshold amount; and
output a third visible or audible signal when the force signal does not exceed the set point signal by the first threshold amount and when the set point signal does not exceed the force signal by the second threshold amount.

14. The cold planer of claim 1, wherein the calibration signal indicates a manner in which the force transducer is to be calibrated.

15. A cold planer comprising a frame, at least one traction device configured to support the frame, and an engine supported by the frame and configured to drive the at least one traction device to propel the cold planer, the cold planer comprising:
a milling drum;
one or more conveyors configured to convey material removed by the milling drum;
a force transducer configured to generate a first signal indicative of a magnitude of a force acting on at least a portion of a conveyor of the one or more conveyors;
a controller, in communication with the force transducer, configured to:
compare the first signal and a second signal associated with calibrating the force transducer; and
output a third signal based on comparing the first signal and the second signal; and
an actuator configured to adjust the force transducer based on the third signal.

16. The cold planer of claim 15, wherein the actuator is configured to adjust a position of the force transducer, relative to a belt of the conveyor, based on the third signal.

17. The cold planer of claim 15, wherein the actuator is configured to move the force transducer toward an upper portion of a belt of the conveyor based on the third signal.

18. The cold planer of claim 15, wherein the actuator is configured to move the force transducer away from an upper portion of a belt of the conveyor based on the third signal.

19. A method associated with calibrating a force transducer that measures a magnitude of a force acting on a conveyor of a cold planer, the method comprising:
receiving, by a controller and from the force transducer, a first signal indicative of the magnitude of the force acting on the conveyor of the cold planer;
comparing, by the controller, the first signal and a second signal associated with calibrating the force transducer; and
outputting, by the controller, a third signal, indicative of a relationship between the first signal and the second signal, based on comparing the first signal and the second signal.

20. The method of claim 19, wherein the third signal indicates a manner in which the force transducer is to be adjusted.
